(19) United States
(12) Patent Application Publication
(10) Pub. No.: US 2003/0123817 A1
(43) Pub. Date: Jul. 3, 2003

(54) Method of fabricating an optical fiber module

(76) Inventors: Shin-Tso Han, Kaohsiung (TW); Wen-Hung Chiang, Taipei (TW); Cheng-Shune Shieh, Taipei (TW); Jeng-Feng Chiou, Taipei (TW); Chun-Jung Lin, Taipei (TW)

Correspondence Address: MARTINE & PENILLA, LLP, 710 LAKEWAY DRIVE, SUITE 170, SUNNYVALE, CA, 94085, US

(21) Appl. No.: 10/154,719

(22) Filed: May 24, 2002

(30) Foreign Application Priority Data
Dec. 27, 2001 (TW) 90132634

(51) Int. Cl. G02B 6/42

(52) U.S. Cl. 385/92; 385/88

(57) ABSTRACT

The present invention provides a method of fabricating an optical fiber module. The optical fiber module includes an optical device and an optical fiber side connector for connecting with an optical fiber device. In the method of fabricating the optical fiber module, an optical device side connector with a protruding part at its connection surface is provided at first. Next, the optical device side connector is combined and fitted to the optical device, followed by aligning the optical device and the optical fiber side connector. Finally, an electric current is applied to the protruding part of the optical device side connector to weld the optical device side connector and the optical fiber side connector.

### BACKGROUND OF THE INVENTION

1. Field of the Invention

The present invention relates to an optical fiber module and a method of fabricating the same and, more particularly, to an optical fiber module for emitting light or receiving light and a method of fabricating the same.

2. Description of the Related Art

Coupled with the spread of the Internet craze, the boundary between the virtual world built by the Internet and the physical world of human beings gets more and more indistinct. Based upon the data sharing and low access barrier of the Internet, all sorts of Internet applications have arisen to the real world, for instance, commercial applications such as on-line shopping, on-line banking, video conference, and mobile office, or non-commercial applications such as data search, on-line learning, on-line games and distant medical treatment. The modern Internet not only provides most of the daily necessities of the mankind, but also brings forth indefinite possibilities in future.

In the wake of various applications of the Internet, the problem to start with is the bandwidth insufficiency. Conclusive from a comprehensive survey on all kinds of communication media, optical fibers are the most capable of conforming to the requirements. According to their characteristics, namely, broad in bandwidth, low in attenuation, non-interfered by electromagnetic waves, reliable in security, small in size, and light in weight, they have become the number one choice of communication media. Therefore it is being actively used from as large as intercontinental submarine cables and Internet backbones to as small as school networks, corporate private lines, and even residential community networks.

The most essential device in optical fiber communication is the optical transceiver, which is responsible for the mutual conversion of optical signals and electronic signals. The key component therein is the optical fiber module like the optical sub-assembly (OSA). Referring to FIG. 1, the conventional optical fiber module is composed of an optical device 11 and a hollow sleeve 12. The optical device 11 is inserted and fitted to the hollow sleeve 12 and is fixed by glue, with an error approximately equal to 20 to 30 microns. The shortcoming of this method is that the glue is easily affected by temperature, humidity, or chemical reactions to become soft or deteriorate, causing a three-dimensional (X-, Y-, and Z-axes) deviation, thereby leading to optical signal loss. For the reason that this type of optical fiber modules has the above disadvantages, hence they are implemented in optical signal transmitting systems that do not demand high accuracy.

To improve such situation, manufacturers have recently developed the laser welding technique. In this case, an optical device is fitted to a connector, and then both of those are integrated with a sleeve by laser welding. An error within 1 micron can be obtained. Although this method effectively improves the deviation caused by temperature, humidity, or chemical reactions in the above-mentioned glue-and-fix method, the laser welding machines are expensive in cost, thereby significantly increasing the production cost and making it unfavorable for fast and mass production.

In view of the above-mentioned problems, it is an urgent issue to provide optical fiber modules not only with high accuracy and low production cost but also without deviations induced by temperature, humidity, or chemical reactions, and a method of fabricating the same.

### SUMMARY OF THE INVENTION

In view of the above-mentioned problems, the object of the present invention is to provide a method of fabricating an optical fiber module with high accuracy, low production cost, and no deviation induced by temperature, humidity, or chemical reactions.

To accomplish the object, the optical fiber module in the method of fabricating an optical fiber module according to the present invention includes an optical device and an optical fiber side connector for connecting with an optical fiber device. The method of fabricating the optical fiber module includes the provision of an optical device side connector having a protruding part at its connection surface. Next, the optical device side connector is combined and fitted to the optical device, followed by the alignment of the optical device and the optical fiber side connector. Finally, an electric current is applied to melt the protruding part of the optical device side connector so as to weld the optical device side connector and the optical fiber side connector.

In addition, the present invention also provides another method of fabricating an optical fiber module, wherein the optical fiber module includes an optical device and an optical device side connector for connecting with an optical device. The method of fabricating the optical fiber module includes the provision of an optical fiber side connector having a protruding part at its connection surface for connecting with an optical fiber device. Next, the optical device is aligned with the optical fiber side connector. Finally, an electric current is applied to melt the protruding part of the optical fiber side connector so as to weld the optical device side connector and the optical fiber side connector.

For the reason that the method of fabricating an optical fiber module according to the present invention employs the electric resistance welding method to weld devices in the optical fiber module, the two-dimensional deviation (X- and Y-axes) caused by the effects of temperature, humidity, or chemical reactions in the glue-and-fix method is improved. Meanwhile, the cost of electric resistance welding machines is far less than the expensive laser machines, thereby achieving high accuracy, low production cost, no deviation induced by temperature, humidity, or chemical reactions, as well as favorableness for fast and mass production.

### BRIEF DESCRIPTION OF THE DRAWINGS

These and other objects, features, and advantages of the present invention will become apparent with reference to the following descriptions and accompanying drawings, wherein:

FIG. 1 is a decomposition diagram showing elements of a conventional optical fiber module;

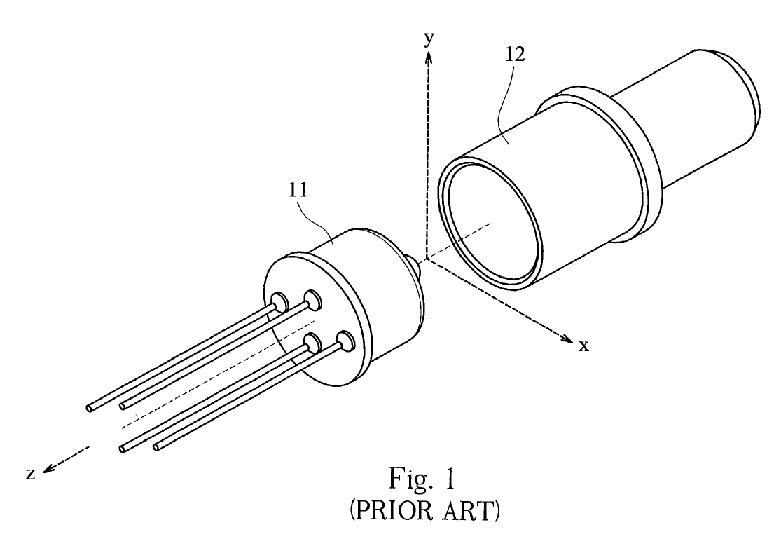

FIG. 2 is a decomposition diagram showing elements of an optical fiber module according to an embodiment of the present invention;

FIG. 3 is a flow diagram showing the steps of a method of fabricating an optical fiber module according to an embodiment of the present invention;

FIG. 4 is a schematic diagram showing an optical fiber according to an embodiment of the present invention;

FIG. 5 is a decomposition diagram showing devices of an optical fiber module according to an embodiment of the present invention; and

FIG. 6 is a flow diagram showing steps of a method of fabricating an optical fiber module according to an embodiment of the present invention.

### DETAILED DESCRIPTION OF THE PREFERRED EMBODIMENTS

A method of fabricating an optical fiber module according to a preferred embodiment of the present invention is hereinafter illustrated with reference to accompanying figures, wherein similar elements are denoted by the same reference numerals.

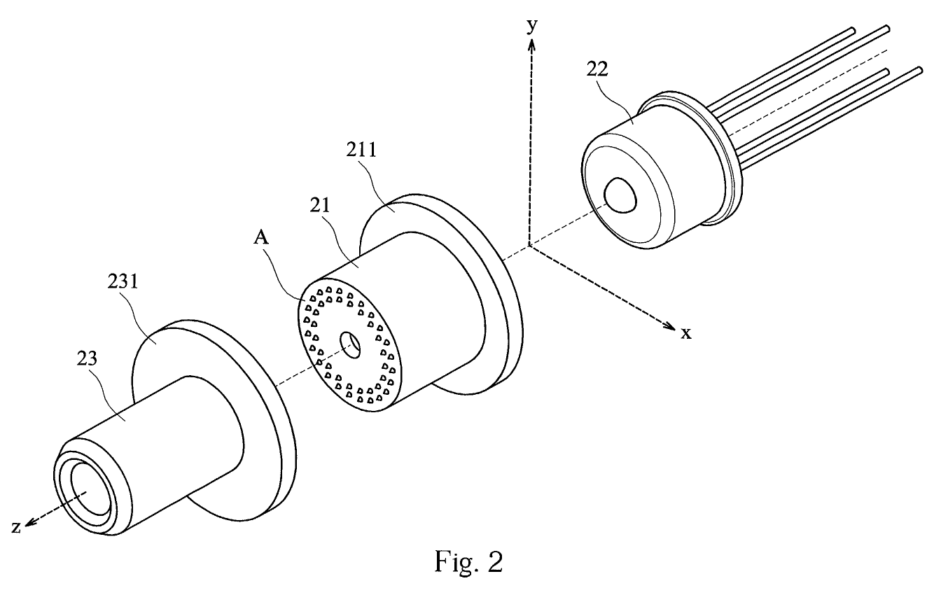

Referring to FIG. 2, in the method of fabricating an optical fiber module according to the preferred embodiment of the present invention, an optical fiber module includes an optical device 22 and an optical fiber side connector 23 for connecting with optical fiber elements. In the embodiment, the optical device 22 may be a light-emitting device, a light-receiving device, or a lens.

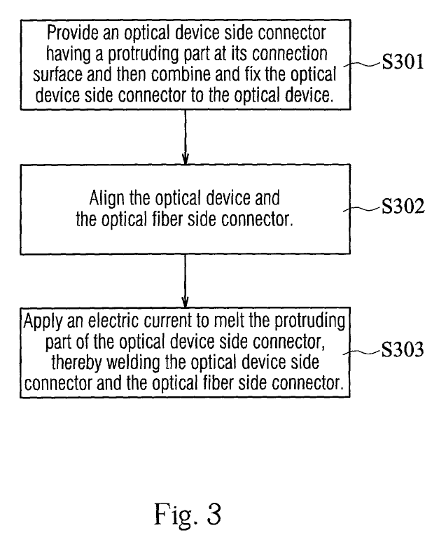

Referring to FIG. 3, the method of fabricating an optical fiber module according to the embodiment of the present invention at first provides an optical device side connector 21 having a protruding part at its connection surface A. Next, the optical device side connector 21 is combined and fitted to the optical device 22 by, for example, electric resistance welding (S301) to avoid deviations in the directions of X- and Y-axes as occurred in the prior art. In step S301, the protruding part at the connection surface A of the optical device side connector 21 consists of a plurality of protruding bumps having sharp tips so as to cooperate with the point discharge method for obtaining better welding results. As shown in FIG. 2, the plurality of protruding bumps may be distributed in the form of a ring over the connection surface A of the optical device side connector 21. Furthermore, the plurality of protruding bumps may be formed onto the connection surface A of the optical device side connector 21 by means of die-casting or composite processing. The next step is to align the optical device 22 and the optical fiber side connector 23 (S302) to make sure that the optical device 22 which has been combined and fitted to the optical device side connector 21 is aligned with the optical fiber side connector 23 in order to have optical signals accurately enter the optical fiber connected with the optical fiber side connector 23. Finally, an electric current is applied between the optical device side connector 21 and the optical fiber side connector 23 to melt the protruding part of the optical device side connector 21 (S303), thereby welding the optical device side connector 21 and the optical fiber side connector 23.

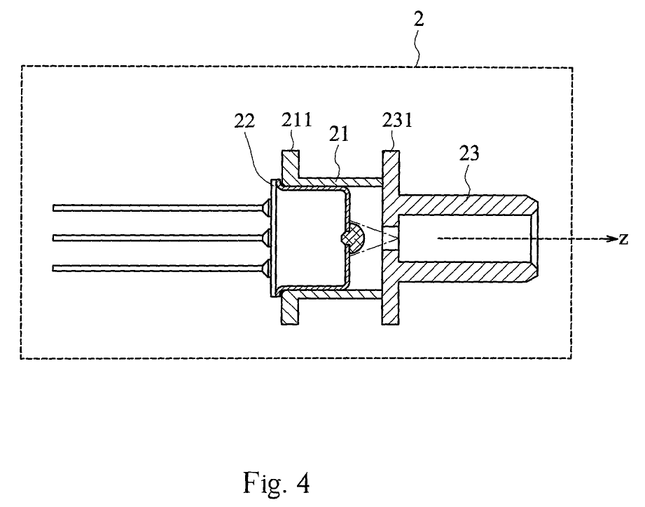

Referring to FIG. 4, in the method of fabricating an optical fiber module according to the present invention, because the plurality of protruding bumps are formed on the connection surface A of the optical device side connector 21, it is only the protruding bumps that are melted to implement the welding such that the optical device side connector 21 and the optical fiber side connector 23 are prevented from damage. Consequently, the connection distance between the optical device side connector 21 and the optical fiber side connector 23 in the direction of connection (Z-axis) is accurately determined and formed. In other words, the light emitted from the optical device 22 can be transmitted and coupled more accurately into the optical fiber.

Referring to FIG. 2 again, the optical device side connector 21 and the optical fiber side connector 23 can have protruding edges 211 and 231, respectively, in order to facilitate the voltage (or current) application and welding grasp. Positive and negative voltages can be applied to the protruding edges 211 and 231 during the application of voltage (or current) such that the optical device side connector 21 and the optical fiber side connector 23 are welded. In addition, the application of voltage (or current) may be implemented by means of multiple times discharge or single time discharge. Take multiple times discharge for instance, the electric current applied is enhanced from small to large, that is, to first spot-weld, in order to remove foreign objects such as excessive charges.

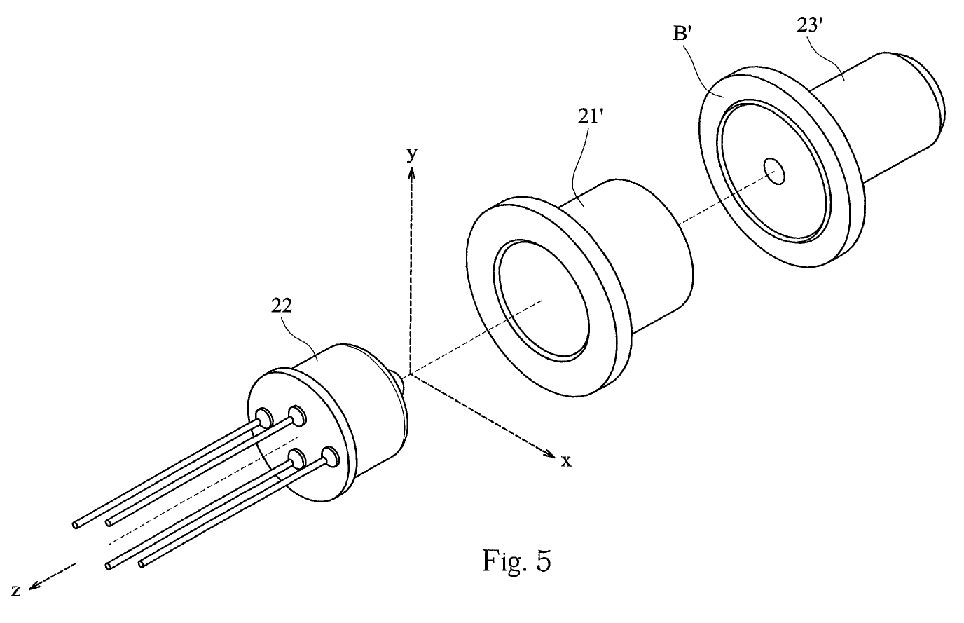

Referring to FIG. 5, the present invention also provides another method of fabricating an optical fiber module. The optical fiber module includes an optical device 22 and an optical device side connector 21′ combined and fitted to the optical device 22. The optical device side connector 21′ and the optical device 22 are fitted together by, for example, electric resistance welding to avoid the deviation in the directions of X- and Y-axes as occurred in the prior art. In the embodiment, the optical device 22 may be a light-emitting device, a light-receiving device, or a lens.

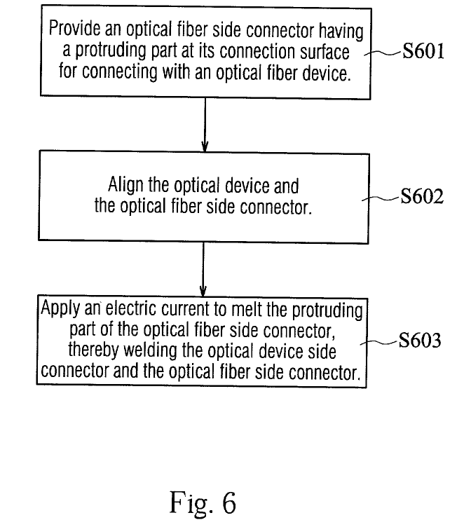

Also referring to FIG. 6, the method of fabricating an optical fiber module according to the embodiment of the present invention at first provides an optical fiber side connector 23′ having a protruding part at its connection surface B′ for connecting with the optical fiber device (S601). The protruding part at the connection surface B′ of the optical fiber side connector 23′ is formed as a ring-shaped protruding strip having a sharp upper edge so as to cooperate with the point discharge method for obtaining better welding results. Moreover, the ring-shaped protruding strip may be formed onto the connection surface B′ of the optical fiber side connector 23′ by means of die-casting or composite processing. The next step is to align the optical device 22 and the optical fiber side connector 23′ (S602) to make sure that the optical device 22 which has been combined and fitted to the optical device side connector 21′ is aligned with the optical fiber side connector 23′ in order to have optical signals accurately enter the optical fiber connected with the optical fiber side connector 23′. Finally, an electric current is applied between the optical device side connector 21′ and the optical fiber side connector 23′ to melt the protruding part of the optical fiber side connector 23′ (S603), thereby welding the optical device side connector 21′ and the optical fiber side connector 23′.

Similarly, as shown in FIG. 5, in the method of fabricating an optical fiber module according to the present invention, because the ring-shaped protruding strip is formed on the connection surface B′ of the optical fiber side connector 23′, it is only the protruding strip that is melted to implement the welding such that the optical device side connector 21′ and the optical fiber side connector 23′ are prevented from damage. Consequently, the connection distance between the optical device side connector 21′ and the optical fiber side connector 23′ in the direction of connection (Z-axis) is accurately determined and formed. Moreover, both of the optical device side connector 21′ and the optical fiber side connector 23′ may have protruding edges used as connection electrodes to facilitate the voltage (current) application and welding grasp during the welding process, similar to the case of the optical device side connector 21 and the optical fiber side connector 23.

To sum up, the method of fabricating an optical fiber module of the present invention, in which electric resistance welding is employed to weld elements in the optical fiber module, is able to improve the two-dimensional deviations in the directions (X- and Y-axes) other than the direction of connection due to effects of temperature, humidity, or chemical reactions in the glue-and-fix method. Meanwhile, the cost of electric resistance welding machines is far less than the expensive laser machines, thereby achieving high accuracy, low production cost, no deviation induced by temperature, humidity, or chemical reactions, as well as favorableness for fast and mass production.

While the present invention has been described by way of example and in terms of the preferred embodiment, it is to be understood that the present invention is not limited to the disclosed embodiment. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of fabricating an optical fiber module, said optical fiber module including an optical device and an optical fiber side connector for connecting to an optical fiber device, comprising the steps of:
providing an optical device side connector having a connection surface, at which a protruding part is formed, to be combined and fixed to said optical device; and
applying an electric current between said optical device side connector and said optical fiber side connector to melt said protruding part of said optical device side connector, thereby welding said optical device side connector and said optical fiber side connector.

2. The method according to claim 1, further comprising the step of: aligning said optical device and said optical fiber side connector.

3. The method according to claim 1, wherein said optical device is one selected from the group consisting of a light-emitting optical device and a light-receiving optical device.

4. The method according to claim 1, wherein said protruding part at said connection surface of said optical device side connector consists of a plurality of protruding bumps.

5. The method according to claim 4, wherein said plurality of protruding bumps are distributed in the form of a ring over said connection surface of said optical device side connector.

6. The method according to claim 1, wherein said protruding part at said connection surface of said optical device side connector consists of at least one protruding strip.

7. The method according to claim 6, wherein said protruding strip is formed in the shape of a ring.

8. The method according to claim 1, wherein said optical device side connector and said optical fiber side connector are welded by means of multiple times discharge.

9. The method according to claim 1, wherein said optical device side connector and said optical fiber side connector are welded by means of single time discharge.

10. The method according to claim 1, wherein said optical device side connector further comprises a protruding edge used as a connection electrode.

11. A method of fabricating an optical fiber module, said optical fiber module including an optical device and an optical device side connector to be combined and fitted to said optical device, comprising the steps of:
providing an optical fiber side connector having a connection surface, at which a protruding part is formed, for connecting with an optical fiber device; and
applying an electric current between said optical device side connector and said optical fiber side connector to melt said protruding part of said optical fiber side connector, thereby welding said optical device side connector and said optical fiber side connector.

12. The method according to claim 11, further comprising the step of:
aligning said optical device and said optical fiber side connector.

13. The method according to claim 11, wherein said optical device is one selected from the group consisting of a light-emitting optical device and a light-receiving optical device.

14. The method according to claim 11, wherein said protruding part at said connection surface of said optical fiber side connector consists of a plurality of protruding bumps.

15. The method according to claim 14, wherein said protruding bumps are distributed in the form of a ring over said connection surface of said optical fiber side connector

16. The method according to claim 11, wherein said protruding part at said connection surface of said optical fiber side connector consists of at least one protruding strip.

17. The method according to claim 16, wherein said protruding strip is formed in the shape of a ring.

18. The method according to claim 11, wherein said optical device side connector and said optical fiber side connector are welded by means of multiple times discharge.

19. The method according to claim 11, wherein said optical device side connector and said optical fiber side connector are welded by means of single time discharge.

20. The method according to claim 11, wherein said optical device side connector further comprises a protruding edge used as a connection electrode.
